(19) United States
(12) Patent Application Publication
(10) Pub. No.: US 2024/0288712 A1
(43) Pub. Date: Aug. 29, 2024

(54) CONTACT LENS INSERT EDGE DESIGN FOR OPTIMAL PERFORMANCE

(71) Applicant: Alcon Inc., Fribourg (CH)

(72) Inventors: Ethan Leveillee, Atlanta, GA (US); Joseph Michael Lindacher, Suwanee, GA (US); David Borja, Suwanee, GA (US); Ying Pi, Cumming, GA (US); Newton T. Samuel, Suwanee, GA (US); Ya-Wen Chang, Alpharetta, GA (US)

(21) Appl. No.: 18/588,225

(22) Filed: Feb. 27, 2024

Related U.S. Application Data
(60) Provisional application No. 63/487,403, filed on Feb. 28, 2023.

(51) Int. Cl. G02C 7/04

(52) U.S. Cl. CPC G02C 7/04

(57) ABSTRACT

A bi-layer contact lens having an insert embedded in a bulk hydrogel material. The insert comprises at least one peripheral edge, wherein the peripheral edge of the insert is configured to provide improved lens performance by selective application of at least one design parameter selected from width, angle, shape configuration, and combinations thereof the peripheral edge of the insert.

This application claims the benefits under 35 USC § 119 (e) of U.S. provisional application No. 63/487,403, filed on 28 Feb. 2023, incorporated by reference in its entirety.

The present invention relates generally to the field of vision correction, and more particularly to bi-layer contact lenses comprising an insert portion that is surrounded by a carrier portion made of a bulk material and comprises one layer of the bulk material and a circular or annular insert made of a layer of a crosslinked polymeric material.

### TECHNICAL FIELD

### Background

Presbyopia results from a gradual loss of accommodation of the visual system of the human eye. This is due to an increase in the modulus of elasticity and growth of the crystalline lens of the eye that is located just behind the iris and the pupil. Tiny muscles in the eye called ciliary muscles pull or release the crystalline lens, thereby causing the curvature of the crystalline lens to adjust. This adjustment of the curvature of the crystalline lens results in an adjustment of the eye's focal power to bring near objects into focus. As individuals age, the crystalline lens of the eye becomes less flexible and elastic, and, to a lesser extent, the ciliary muscle strength decreases. These changes result in the reduction of accommodative amplitude (i.e., loss of accommodation) which causes objects that are close to the eye to appear blurry. Symptoms of presbyopia result in the inability to focus on objects close at hand. As the modulus of the lens increases, it is unable to form images of intermediate and near distance objects on the retina. People that are symptomatic typically have difficulty reading small print, such as that on computer display monitors, restaurant menus and newspaper advertisements, and may need to hold reading materials at arm's length.

There are a variety of non-surgical corrective systems that are currently used to treat presbyopia, including bifocal spectacles, progressive (no-line bifocal) spectacles, reading spectacles, bifocal or multifocal contact lenses, and monovision contact lenses. Surgical corrective systems include, for example, multifocal intraocular lenses (IOLs) and accommodation IOLs inserted into the eye and vision systems altered through corneal ablation techniques.

Bi-layer contact lenses for correction of presbyopia may be provided with a lens insert portion embedded into or applied onto a carrier portion, forming an insert-carrier interface therebetween. The insert portion typically is formed from a material having a substantially different index of refraction than that of the carrier portion. Some bi-layer contact lenses have been found to impart optical (Fresnel) distortion within the wearer's field of vision due to different indices of refraction of the insert and carrier, and/or to be prone to delamination or separation of the insert from the carrier, material warping or deformation of the lens, and/or surface irregularities at the interface on the contact lens surface, all of which negatively affect lens performance. Delamination and material warping may in some instances and to some extent be controlled by means such as adhesion promotion and selective material combination; and clinical performance (such as comfort) may in some instances and to some extent be controlled by the design of the carrier and insert independent of the edge. However, adding adhesion promotion or limiting selection of materials may create additional and undesired limitations on overall lens design and performance, and may result in increased performance challenges, such as increased deformation and/or delamination, and/or may also affect clinical performance such as negatively impacting comfort.

Accordingly, it can be seen that needs exist for improvements to insert edge and insert-carrier interface designs for bi-layer contact lenses. It is to the provision of improved insert edge and insert-carrier interface designs for bi-layer contact lenses meeting these and other needs that the present invention is primarily directed.

### SUMMARY

In example embodiments, the present invention provides improved insert edge and insert-carrier interface designs for bi-layer contact lenses. It has been discovered that various factors, including the width, the angle, the geometric configuration, and/or the position of the insert edge and the interface between the insert portion and the carrier portion, and combinations of those factors, may have significant effects on lens performance. Example embodiments of the present invention are directed to improvements and optimization of the insert edge design and the insert-carrier interface of bi-layer contact lenses. Example embodiments of the insert edge and insert-carrier interface designs according to the present invention may provide improved or optimized optical performance of the lens, better control or eliminate optical (Fresnel) distortion within the wearer's field of vision, reduce or eliminate delamination or separation of the insert from the carrier, reduce or eliminate material warping or deformation of the lens, minimize or eliminate surface irregularities at the insert-carrier interface on the contact lens surface, and/or reduce or eliminate discomfort to the wearer.

In one aspect, the present invention relates to a bi-layer contact lens including an anterior surface, an opposite posterior surface, a bulk hydrogel material, and an insert embedded in the bulk hydrogel material. The insert is made of a polymeric material different from the bulk hydrogel material and has a convex surface, an opposite concave surface, and a peripheral edge. The insert is located in an insert portion of the bi-layer contact lens which is surrounded by a carrier portion made of the bulk hydrogel material. The insert portion comprises the insert and one layer of the bulk hydrogel material in direct contact with the insert via one of the convex and concave surfaces. The peripheral edge of the insert is configured to provide improved lens performance. In various preferred embodiments, the peripheral edge of the insert is configured to optimize lens performance by selective application of at least one design parameter selected from width, angle, shape configuration, and combinations thereof at the peripheral edge of the insert.

In another aspect, the invention relates to a method of optimizing performance of a bi-layer contact lens. The contact lens includes an anterior surface, an opposite posterior surface, a bulk hydrogel material, and an insert embedded in the bulk hydrogel material. The insert is made of a polymeric material different from the bulk hydrogel material and has a convex surface, an opposite concave surface, and a peripheral edge. The insert is located in an insert portion of the bi-layer contact lens, which is surrounded by a carrier portion made of the bulk hydrogel material. The insert portion comprises the insert and one layer of the bulk hydrogel material in direct contact with the insert via one of the convex and concave surfaces. The method includes selective application of at least one design parameter selected from width, angle, shape configuration, and combinations thereof the peripheral edge of the insert.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a plan view of a bi-layer contact lens having a lens insert portion and a carrier portion according to an example embodiment of the present invention.

FIG. 2A is a cross-sectional view of a bi-layer contact lens having a lens insert portion and a carrier portion according to an example embodiment of the present invention.

FIG. 2B is a detailed cross-sectional view of the insert-carrier interface of the contact lens of FIG. 2A.

FIG. 3 is a detailed cross-sectional view of another insert-carrier interface of a contact lens according to another example embodiment.

FIG. 4 is a detailed cross-sectional view of another insert-carrier interface of a contact lens according to another example embodiment.

FIG. 5A is a cross-sectional view of a bi-layer contact lens having a lens insert portion and a carrier portion according to another example embodiment of the present invention.

FIG. 5B is a detailed cross-sectional view of the insert-carrier interface of the contact lens of FIG. 5A.

FIG. 6 is a detailed cross-sectional view of another insert-carrier interface of a contact lens according to another example embodiment.

FIG. 7 is a detailed cross-sectional view of another insert-carrier interface of a contact lens according to another example embodiment.

FIG. 8A is a plan view of a bi-layer contact lens having an annular lens insert portion and a carrier portion according to another example embodiment of the present invention.

FIG. 8B is a cross-sectional view of the contact lens of FIG. 6A.

FIG. 9 is a cross-sectional view of a contact lens according to another example embodiment of the present invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. Also, any use of the terms “about,” “approximately,” “substantially,” and/or “generally” are intended to mean the exact value or characteristic indicated, as well as close approximations that are understood by persons of ordinary skill in the art to be sufficiently close to the exact value or characteristic based on the context of the intended use and application. In addition, any methods described herein are not intended to be limited to the sequence of steps described but can be carried out in other sequences, unless expressly stated otherwise herein.

“About” as used herein in this application means that a number, which is referred to as “about”, comprises the recited number plus or minus 1-10% of that recited number.

A “hydrogel” or “hydrogel material” refers to a crosslinked polymeric material which has three-dimensional polymer networks (i.e., polymer matrix), is insoluble in water, but can hold at least 10% by weight of water in its polymer matrix when it is fully hydrated (or equilibrated).

A “silicone hydrogel” or “SiHy” refers to a silicone-containing hydrogel obtained by copolymerization of a polymerizable composition comprising at least one silicone-containing monomer or at least one silicone-containing macromer or at least one crosslinkable silicone-containing prepolymer.

A siloxane, which often also described as a silicone, refers to a molecule having at least one moiety of —Si—O—Si— where each Si atom carries two organic groups as substituents.

As used in this application, the term “non-silicone hydrogel” or “non-silicone hydrogel material” interchangeably refers to a hydrogel that is theoretically free of silicon.

An “insert” refers to any 3-dimensional article which has a dimension of at least 5 microns but is smaller in dimension sufficient to be embedded in the bulk material of an embedded hydrogel contact lens and which is made of a material (preferably a non-hydrogel material) that is different from the bulk hydrogel material.

In accordance with the invention, a non-hydrogel material can be any material that can absorb less than 5% (preferably about 4% or less, more preferably about 3% or less, even more preferably about 2% or less) by weight of water when being fully hydrated.

In accordance with the invention, an insert of the invention has a thickness less than any thickness of an embedded hydrogel contact lens in the region where the insert is embedded. An insert can be any object have any geometrical shape and can have any desired functions.

The term “anterior surface”, “front surface”, “front curve surface” or “FC surface” in reference to a contact lens or an insert, as used in this application, interchangeably means a surface of the contact lens or insert that faces away from the eye during wear. The anterior surface (FC surface) is convex.

The “posterior surface”, “back surface”, “base curve surface” or “BC surface” in reference to a contact lens or insert, as used in this application, interchangeably means a surface of the contact lens or insert that faces towards the eye during wear. The posterior surface (BC surface) is concave.

In example embodiments, the present invention provides improved control of lens performance in the design, manufacture and use of bi-layer contact lenses, for example in terms of lens deformation, delamination, and clinical performance and user comfort, as compared to previously known lenses, methods and systems. Depending on the final bi-layer lens design (such as thickness, diameter, etc.) and insert and carrier (i.e., bulk hydrogel) material combination, the design of the peripheral edge of an insert will be selected and implemented. In example embodiments, the design of the peripheral edge will optimize or control lens performance to reduce, minimize or prevent deformation and/or delamination, and to improve clinical performance of the lens. The design of the bi-layer lens platform and the manufacturing process is flexible enough to allow for a range of designs, giving great flexibility to control these parameters. In some particular embodiments of the invention, the final parameters of the peripheral edge of an insert will be dependent on factors including the overall lens design and material selections.

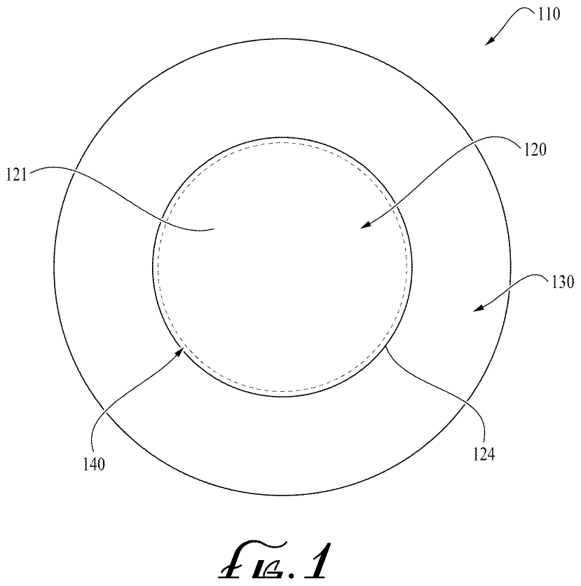

With reference now to the drawing figures, wherein like reference numbers represent corresponding parts throughout the several views, FIG. 1 shows a contact lens 110 according to an example embodiment of the invention in plan view (i.e., viewed from the front or back side of the lens). The lens 110 is a bi-layer contact lens having an insert portion 120 and an annular portion 130 made of a bulk hydrogel material. In example embodiments, the insert portion 120 and the annular portion 130 are generally circular, and the insert portion is generally concentric with the annular portion, with the annular portion surrounding the insert portion in an annular or ring-shaped configuration. The insert portion 120 comprises an insert 121 and a layer of the bulk hydrogel material contiguous with an embedded surface of the insert.

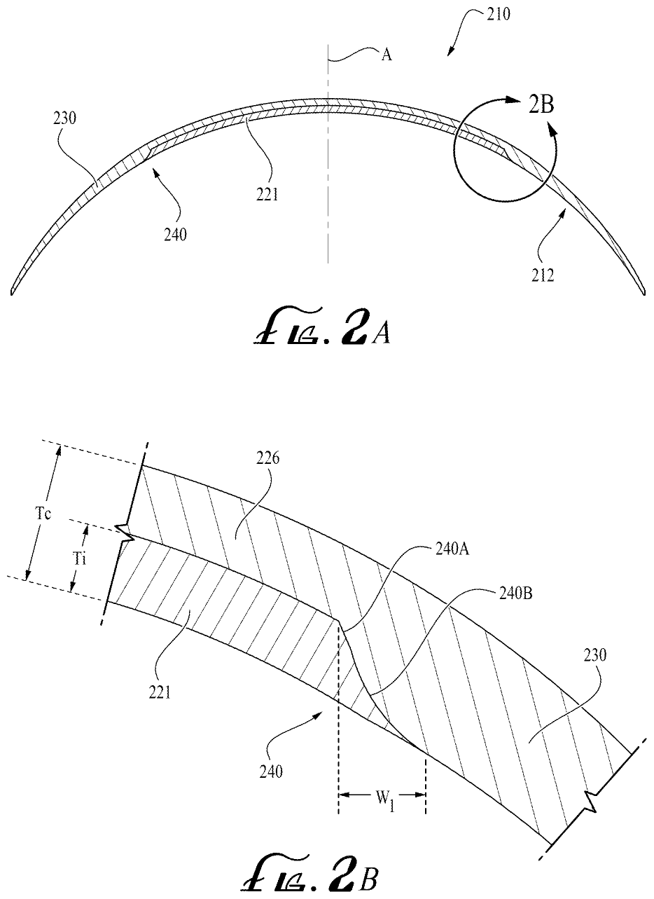

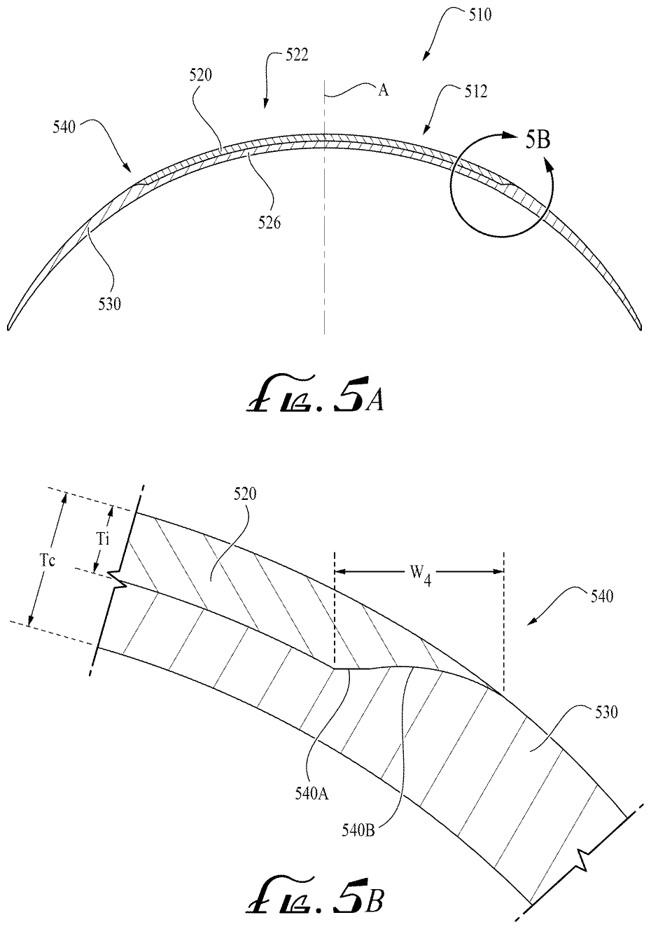

The insert 121 comprises a concave surface, an opposite convex surface in direct contact with the layer of the bulk hydrogel material, and a peripheral edge 124. A generally circular radial insert-carrier interface 140 is defined between the peripheral edge 124 of the insert 121 and the annular portion 130 of the lens 110 extending around the periphery or outer circumference or perimeter of the insert 121. In some embodiments, for example as described below with reference to FIGS. 2-4, the insert 121 may be embedded into or applied onto the base curve or back side of the lens 110. In other example embodiments, for example as described below with reference to FIGS. 5-7, the insert 121 may be embedded into or applied onto the front curve or front side of the lens 110. Depending upon the thickness of the insert 121 and the geometry of the outer periphery of the insert 121, the insert-carrier interface 140 may extend between an outer diameter or periphery (indicated in solid lines) and an inner diameter or periphery (indicated in broken lines) spanning a width-wise or radial distance at different depths within the lens body. In particular example embodiments, the outer diameter of the overall lens 110 (i.e., measured at the outer periphery of the annular portion 130) may be between about 12.5 mm to about 15.5 mm, for example about 14 mm; and the outer diameter of the lens insert 121 (i.e., measured at the insert-carrier interface 140) may be between 7 mm to 13 mm, for example about 10 mm. In example embodiments, the insert 121 is formed of a first material having a first refractive index, and the annular portion and the layer of the bulk hydrogel material are formed of a second material different from the first material and having a second refractive index different from the first refractive index. In example embodiments, the differential between the first refractive index and the second refractive index is at least about 0.05. In some example embodiments, the lens insert portion 120 may comprise a diffractive lens element (i.e., an insert) formed of a relatively harder material and having a relatively higher diffractive index, and the lens carrier portion may comprise an insert made of a relatively softer material having a relatively lower diffractive index. In alternate embodiments, the material selections may be reversed. In further example embodiments, one or more additional layers, coatings, optical elements of the same or different materials may be provided on or in the lens 110.

Any suitable insert materials and any suitable carrier material (i.e., hydrogel materials) can be used in the present invention. Examples of preferred insert materials and carrier materials include without limitation those materials disclosed in U.S. Pat. Appl. Pub. Nos. 2022/0324187 A1, 2022/0326412 A1, 2022/0306810 A1, and 2023/0004023 A1, all of which are incorporated by reference in their entireties.

In various preferred embodiments, the insert is made of a crosslinked polymeric material having a first refractive index, wherein the bulk hydrogel material (i.e., carrier material) is a silicone hydrogel material having a second refractive index, wherein the first refractive index is at least 0.05 (preferably at least 0.07, more preferably at least 0.09, even more preferably at least 0.10) higher than the second refractive index.

In those preferred embodiments, the crosslinked polymeric material of the insert has a refractive index of at least about 1.47, preferably at least about 1.49, more preferably at least about 1.51, even more preferably at least about 1.53. Optionally but preferably, the crosslinked polymeric material of the insert has an oxygen permeability of at least about 40 barrers, preferably at least about 60 barrers, more preferably at least about 80 barrers, even more preferably at least about 100 barrers. Such preferred insert materials are described in U.S Pat. Appl. Pub. No. 2023/0004023 A1 (which is incorporated by reference in its entirety).

In accordance with the invention, the silicone hydrogel material (i.e., carrier material) has an equilibrium water content (i.e., in fully hydrated state or when being fully hydrated) of from about 20% to about 70% (preferably from about 20% to about 65%, more preferably from about 25% to about 65%, even more preferably from about 30% to about 60%) by weight, an oxygen permeability of at least about 40 barrers (preferably at least about 60 barrers, more preferably at least about 80 barrers, more preferably at least about 100 barrers), and a modulus (i.e., Young's modulus) of about 1.5 MPa or less (preferably from about 0.2 MPa to about 1.2 MPa, more preferably from about 0.3 MPa to about 1.1 MPa, even more preferably from about 0.4 MPa to about 1.0 MPa). Such preferred carrier materials (i.e., silicone hydrogel materials) are described in U.S Pat. Appl. Pub. No. 2023/0004023 A1 (which is incorporated by reference in its entirety).

FIGS. 2A and 2B show a further example embodiment of a contact lens 210, in cross-sectional side view, wherein the insert 221 is embedded on the lens's concave base curve or back side 212 (i.e., the side of the lens that confronts the eye of the wearer when in use and the layer 226 of the bulk hydrogel material in direct contact with the convex surface of the insert 221) in the insert portion 220, surrounded by the lens carrier's annular portion 230 and defining an insert-carrier interface 240 at the region of the lens between the outer periphery of the insert and the carrier. The lens insert-carrier interface 240 is shown in greater detail in FIG. 2B. As shown, the insert 221 has a thickness Tᵢ at least partially embedded within the overall thickness T_{c} of the lens body (wherein the thicknesses are measured normal to a tangent to the curvature of the lens). In example embodiments, the thickness Tᵢ is between about 10% to about 90%, for example about 50% the overall lens thickness T_{c}. In one embodiment example, the insert thickness of 25 μm and the lens body thickness of 115 μm would correspond to a total thickness of 140 μm. In another embodiment example, the insert thickness of 75 μm and a lens body thickness of 75 μm would correspond to a total thickness of 150 μm.

In some example embodiments, and as seen in greater detail in FIG. 2B, the peripheral edge of the insert 221 at the insert-carrier interface 240 comprises a segmented edge geometry for improved lens performance. In the depicted embodiment, the insert-carrier interface 240 comprises a tapered inner first segment 240A, which is generally flat or linear in cross-sectional profile, and generally frustoconical in three-dimensional configuration; and an arcuate or curved outer or peripheral second segment 240B. In example embodiments, the tapered first segment 240A spans a radial distance of between about 0.1 to about 100 μm, for example about 25 μm; and the arcuate second segment 240B spans a radial distance of between about 25 to about 500 μm, for example about 225 μm. In further example embodiments, the tapered first segment 240A may extend at an angle of between about 90° to about 170°, for example about 120° with respect to a cylindrical axis parallel to the lens central axis A. In further example embodiments, the radius of curvature of the arcuate second segment 240B may be between about 25 to 500 μm, for example about 225 μm in radius. In further example embodiments, the insert-carrier interface 240 spans a radial distance or transition width W₁ of between about 0.25 to 0.5 mm, measured in a transverse direction normal or perpendicular to the central axis A of the lens 210.

In other example embodiments, and as seen with reference to FIG. 3, the outer peripheral edge of the insert 320 comprises an angled, chamfered or beveled edge 322, defining a generally straight or linear frustoconical outer or peripheral side surface oriented or tapered at an oblique (acute or obtuse) angle α relative to a cylindrical axis A′ extending parallel to and concentric with the central axial axis A of the lens 310 and spaced a radial distance therefrom, tapering outwardly wider towards the base curve or inside face of the lens. The angled edge 322 defines a width W₂, between inner and outer peripheral edges of the insert 320, in a transverse direction generally perpendicular to the axial direction of the central axis A. Selective control of the angle α and/or width W₂ of the insert-carrier interface 340 between the insert 320 and the bulk hydrogel carrier lens material of the lens annular portion 330 allows optimization and improved control of the lens performance, for example to reduce, minimize or prevent deformation and/or delamination; and/or to improve clinical performance of the lens, for example by reducing, eliminating or controlling optical (Fresnel) distortion, and/or improving wearer comfort by reducing awareness of the insert-lens body interface. In some particular example embodiments, the angle α of the insert-carrier interface 340 between the angled edge 322 and the cylindrical axis A′ is between about 1.0° to about 20.0°, for example about 10.00°. In further particular example embodiments, the width W₁ between the inner and outer peripheral edges of the insert 221 is between about 25 to 500 μm.

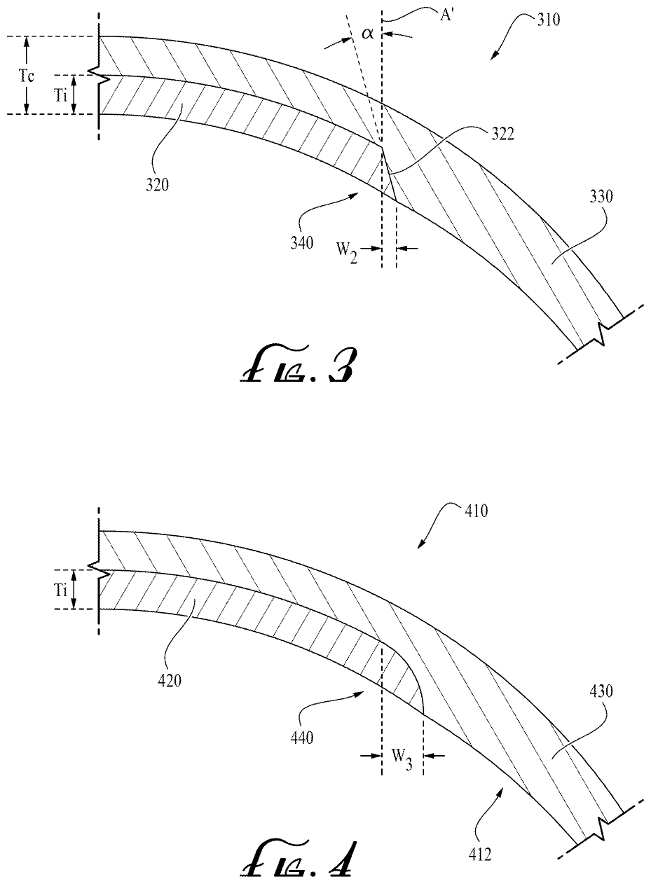

FIG. 4 shows another example embodiment of an insert-carrier interface portion of a bi-layer contact lens 410, in detailed cross-sectional side view. Similar to the above-described embodiments, the lens insert portion 420 is embedded on the concave base curve or back side 412 of the lens carrier portion 430. Rather than a straight angled transition, the outer peripheral edge of the insert 420 comprises a rounded, radiused, or smoothly tapered transition configuration at the insert-carrier interface 440. The transition region of the insert-carrier interface 440 defines a width W₃, between inner and outer surfaces of the insert 420, in a transverse direction generally perpendicular to the axial direction of the central axis A of the lens 410. In some particular example embodiments, the width W₂ is between about 0.25 mm to about 0.5 mm, for example about 0.35 mm. Alternatively, the width W₂ of the rounded transition region of the insert-carrier interface 440 may be defined in proportion to the thickness Tᵢ of the insert 321, for example the width W₂ being equal to or greater than the thickness Tᵢ, and in other examples the width W₂ being between 0.75 to 1.5 times the thickness Tᵢ, or in particular examples the width W₂ being about 1.0 to 1.25 times the thickness Tᵢ. In example embodiments, the radius of curvature of the insert lens edge is sufficiently large so that it doesn't curl under itself, causing an overhang. This is generally dependent on the thickness of the insert, with larger insert thicknesses typically utilizing a larger radius of curvature at the insert edge.

FIG. 5A shows a further example embodiment of a contact lens 510, in cross-sectional side view. In this embodiment, the insert 520 is embedded on the lens's convex front curve or front side 512 (i.e., the side of the lens away from the eye of the wearer when in use), and a layer 526 of the bulk hydrogel material is in direct contact and contiguous with the concave surface of the insert 421, in the insert portion 522 surrounded by the annular portion 530 but is otherwise substantially similar to the above-described embodiments. An insert-carrier interface 540 is defined at the region of the lens 510 between the outer periphery of the insert 520 and the bulk hydrogel carrier material of the lens annular portion 530. The lens insert-carrier interface 540 is shown in greater detail in FIG. 5B. As shown, the insert 520 has a thickness Tᵢ at least partially embedded within the overall thickness T_{c} of the lens body. In example embodiments, the thickness Tᵢ is between about 25% to about 75%, for example about 50% the thickness T_{c}. In the depicted example embodiment, the outer peripheral edge of the insert 520 at the insert-carrier interface 540 comprises a segmented edge geometry for improved lens performance. The segmented edge geometry comprises a tapered inner first segment 540A, which is generally flat or linear in cross-sectional profile, and generally frustoconical in three-dimensional configuration; and an arcuate or curved outer or peripheral second segment 540B. In example embodiments, the tapered first segment 540A spans a radial distance of between about 0 to 100 μm, for example about 25 μm; and the arcuate second segment 540B spans a radial distance of between about 25 to 500 μm, for example about 225 μm. In further example embodiments, the tapered first segment 540A may extend at an angle of between about 90° to 170°, for example about 120° with respect to a cylindrical axis parallel to the lens central axis A. In further example embodiments, the radius of curvature of the arcuate second segment 540B may be between about 25 to 500 μm, for example about 225 μm in radius. In further example embodiments, the insert-carrier interface 540 spans a radial distance or transition width W₄ of between about 0.25 to 0.5 mm, measured in a transverse direction normal or perpendicular to the central axis A of the lens 510.

FIG. 6 shows another example embodiment of a lens 610 having an insert 620 on the convex front curve 612 of the lens, surrounded by the annular carrier lens portion 630. The insert 620 comprises an angled, chamfered or beveled edge 624, defining a generally straight or linear frustoconical outer or peripheral side surface oriented or tapered at an oblique (acute or obtuse) angle α relative to a cylindrical axis A′ extending parallel to and concentric with the central axial axis A of the lens 610 and spaced a radial distance therefrom, tapering outwardly wider towards the front curve or outside face 612 of the lens. The angled edge 624 defines a width W₅, between inner and outer peripheral edges of the insert 620, in a transverse direction generally perpendicular to the axial direction of the central axis A. Selective control of the angle α and/or width W₅ of the insert-carrier interface 640 allows optimization and improved control of the lens performance, for example to reduce, minimize or prevent deformation and/or delamination; and/or to improve clinical performance of the lens, for example by reducing, eliminating or controlling optical (Fresnel) distortion, and/or improving wearer comfort. In some particular example embodiments, the angle α of the insert-carrier interface 440 between the angled edge 424 and the cylindrical axis A′ is between about 0° to about 175°, for example about 60°. In further particular example embodiments, the width W₃ between the inner and outer peripheral edges of the insert 421 is between about 0.25 mm to about 1.0 mm, for example about 0.35 mm.

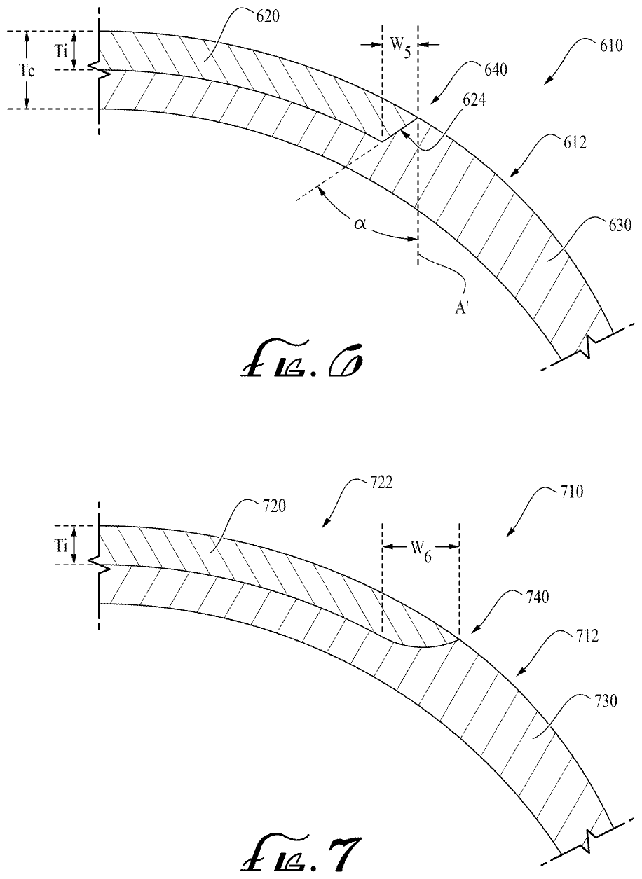

FIG. 7 shows another example embodiment of an insert-carrier interface portion of a bi-layer contact lens 710, in detailed cross-sectional side view. Similar to the above-described FIGS. 5 and 6 embodiments, the insert 720 is embedded on the lens's convex front curve or front side 712 in the insert portion 722 which is surrounded by the annular lens portion 730. Rather than a straight angled transition, the outer peripheral edge of the insert 720 comprises a rounded, radiused, or smoothly tapered transition configuration at the insert-carrier interface 740. The transition region of the insert-carrier interface 740 defines a width W₆, between inner and outer surfaces of the insert 720, in a transverse direction generally perpendicular to the axial direction of the central axis A. In some particular example embodiments, the width W₆ is between about 0.1 mm to about 1 mm, for example about 0.35 mm. Alternatively, the width W₄ of the rounded transition region of the insert-carrier interface 740 may be defined in proportion to the thickness Tᵢ of the insert 720, for example the width W₄ being equal to or greater than the thickness Tᵢ, and in other examples the width W₄ being between 0.75 to 1.5 times the thickness Tᵢ, or in particular examples the width W₄ being about 1.0 to 1.25 times the thickness Tᵢ.

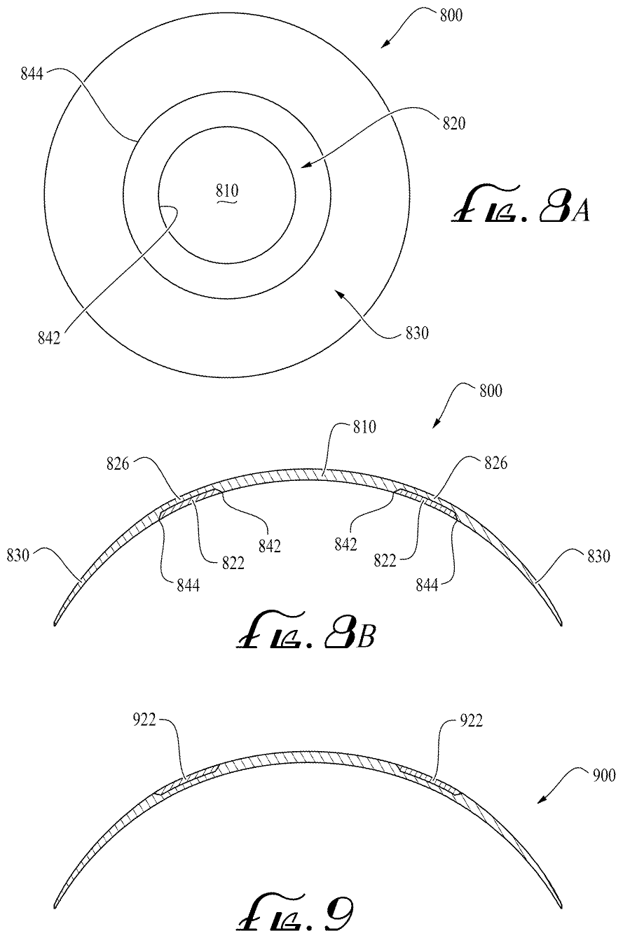

FIGS. 8A and 8B show a further example embodiment of a contact lens 800 in plan view. The contact lens 800 comprises a circular central lens portion 810 surrounded immediately by an insert portion 820 which is surrounded immediately by a lens carrier annular portion 830. In this embodiment, both the central lens portion 810 and the lens carrier annular portion 830 are made of the bulk hydrogel material; and the insert portion 820 has an annular ring shape zone and comprises an insert 822 and a layer 826 of the bulk hydrogel material. The insert 822 has a concave surface extending smoothly continuous with the lens base curve, an opposite convex surface contiguous with the layer 826 of the bulk hydrogel material, an inner peripheral edge 842, and an outer peripheral edge 844. The insert portion 820 is arranged generally concentrically with the circular central lens portion 810. The lens 800 is otherwise substantially similar to the above-described embodiments. In some example embodiments, the lens 810 may have a clear center aperture, for example for use in treatment of myopia. In example embodiments, the overall lens 810 may have an outside diameter of about 14 mm, the outer peripheral edge 844 may have a diameter of about 7-13 mm, and the inner peripheral edge 842 may have a diameter of about 2-5 mm. As shown in FIG. 8B, the insert 821 may be embedded or applied to the base curve or back surface of the lens; or alternatively as shown in FIG. 9, an annular insert 922 may be embedded or applied to the front curve or front surface of the lens 900 in otherwise similar fashion. Also, in different example embodiments, the peripheral edges of the insert may be segmented similar to FIGS. 2 and 5, or may be generally straight angled similar to FIGS. 3 and 6, or may be radiused or rounded similar to FIGS. 4 and 7, or may be otherwise configured.

The present invention includes systems and methods of design, manufacture and/or use of contact lenses, as well as the contact lenses themselves. The design of the edge of the insert and the location, configuration, and geometry of the insert-carrier interface impacts the performance of the lens. Different design features and parameters included in example systems and methods of the present invention include selective control of the width, angle, and geometry (e.g., straight vs. curved edge) of the insert edge and insert-carrier interface of a bi-layer contact lens. Deformation of the lens and delamination can be major issues depending on the types/combinations of materials being used. Different materials and overall lens design (such as insert thickness) may require different shapes. Example edge designs are meant to solve challenges regarding lens shape and production.

In example embodiments, lenses according to the present disclosure may be manufactured by molding processes comprising the steps:

For a lens with the insert lens on the base curve:
dose the insert formulation into the first female mold;
engage the male mold to form the insert;
cure the insert;
remove the male mold with the insert attached to the male mold;
does the bulk hydrogel formulation into the second female mold which will form the bulk hydrogel portion;
engage the male mold with the insert attached into the second female mold; and
cure to complete the lens.

Or alternatively, for a lens with the insert lens on the base curve:
dose the bulk hydrogel formulation into the female mold;
engage a first male mold half and cure to form the bulk hydrogel portion of the lens (with a recess where the insert lens will be formed);
dose the insert lens formulation into the female mold half (into the recess left in the preceding step); and
engage a second male mold half and cure to form the complete lens.

And for a lens with the insert lens on the front curve:
dose the insert lens formulation into the female mold half;
engage a first male mold half and cure to form the insert lens;
remove the first male mold half and dose the bulk hydrogel formulation into the female mold half to encapsulate the insert lens; and
engage a second male mold half and cure to form the complete lens.
   Additionally, in example embodiments, the lens mold angles may preferably be above zero, to create a draft for removal from the mold. If a particular material proves too difficult to remove from the mold, increasing the mold angle may make it easier.

The disclosed example embodiments demonstrate some of the variables that are controllable to produce the desired results. Many parameters can be adjusted, including width, angle, and tapered vs. straight insert edge and insert-carrier interface configurations, and are within the scope of the invention. In some example embodiments, the final design of a particular insert edge and/or insert-carrier interface will be dependent on the materials used, and desired performance of the particular lens. Accordingly, the lens designs, and the systems and methods of lens design, manufacture and use disclosed herein are by way of example embodiments within the scope of the invention and are not intended to be limiting. In addition, it should be understood that aspects of the various embodiments of the invention may be interchanged either in whole or in part or can be combined in any manner and/or used together, e.g., the following embodiments as illustrated below:
1. A bi-layer contact lens comprising an anterior surface, an opposite posterior surface, a bulk hydrogel material, an insert embedded in the bulk hydrogel material, an insert portion, and a carrier portion, wherein the insert is made of a crosslinked polymeric material different from the bulk hydrogel material and has a convex surface, an opposite concave surface, and at least one peripheral edge, wherein the insert portion is surrounded immediately by the carrier portion made of the bulk hydrogel material, wherein the insert portion comprises the insert and a layer of the bulk hydrogel material in direct contact with the insert via one of the convex and concave surfaces, and wherein said at least one peripheral edge of the insert is configured to provide improved lens performance.
2. The bi-layer contact lens of Embodiment 1, wherein the bi-layer contact lens has a diameter of about 12.5 mm to about 15.5 mm, wherein said at least one peripheral edge of the insert is configured to provide improved lens performance by selective application of at least one design parameter selected from width, angle, shape configuration, and combinations thereof the peripheral edge of the insert.
3. The bi-layer contact lens of Embodiment 1 or 2, wherein the shape configuration of said at least one peripheral edge of the insert is selected from a straight angled shape configuration or a rounded shape configuration.
4. The bi-layer contact lens of any one of Embodiments 1 to 3, wherein the layer of the bulk hydrogel material in the insert portion is directly in contact with the convex surface of the insert.
5. The bi-layer contact lens of any one of Embodiments 1 to 3, wherein the layer of the bulk hydrogel material in the insert portion is directly in contact with the concave surface of the insert.
6. The bi-layer contact lens of any one of Embodiments 1 to 5, wherein said at least one peripheral edge of the insert comprises a segmented edge geometry which comprises a tapered inner first segment an outer second segment, wherein the tapered inner first segment is flat or linear in cross-sectional profile (i.e., frustoconical in three-dimensional configuration) whereas the tapered outer second segment is arcute or curved in in cross-sectional profile.
7. The bi-layer contact lens of Embodiment 6, wherein the tapered inner first segment spans a radial distance of between about 0.1 to about 100 μm, wherein the tapered outer second segment spans a radial distance of between about 25 to about 500 μm.
8. The bi-layer contact lens of Embodiment 6 or 7, wherein the tapered inner first segment extends at an angle of between about 90° to about 170° with respect to a cylindrical axis parallel to the lens central axis of the bi-layer contact lens
9. The bi-layer contact lens of any one of Embodiments 6 to 8, wherein the tapered outer second segment is arcute and has a radius of curvature of from about 25 to about 500 μm.
10. The bi-layer contact lens of any one of Embodiments 6 to 9, wherein said at least one peripheral edge of the insert spans a radial distance of between about 0.25 mm to about 0.5 mm, measured in a transverse direction normal or perpendicular to the central axis of the bi-layer contact lens.
11. The bi-layer contact lens of any one of Embodiments 1 to 5, wherein said at least one peripheral edge is an angled, chamfered or beveled edge that defines a straight or linear frustoconical peripheral side surface, wherein the straight or linear frustoconical peripheral side surface is oriented or tapered at an oblique (arcute or obtuse) angle relative to a cylindrical axis parallel to and concentric with the central axial axis of the bi-layer contact lens, spaces a radial distance therefrom, and tapers outwardly wider towards the base curve of the bi-layer contact lens.
12. The bi-layer contact lens of Embodiment 11, wherein the angled, chamfered or beveled edge spans a radial distance of between about 25 μm to about 500 μm, measured in a transverse direction normal or perpendicular to the central axis of the bi-layer contact lens.
13. The bi-layer contact lens of any one of Embodiments 1 to 5, wherein said at least one peripheral edge is a rounded, radiused or smoothly tapered edge that spans a radial distance of between about 0.25 mm to about 0.50 mm, measured in a transverse direction normal or perpendicular to the central axis of the bi-layer contact lens.
14. The bi-layer contact lens of any one of Embodiments 1 to 13, wherein the insert has an annular ring shape and said at least one peripheral edge comprises an inner peripheral edge and an outer peripheral edge, wherein the insert portion surrounds immediately a circular central lens portion.
15. The bi-layer contact lens of embodiment 14, wherein the outer peripheral edge of the insert has a diameter of from about 7 mm to about 13 mm and the inner peripheral edge of the insert has a diameter of from about 2 mm to about 5 mm.
16. The bi-layer contact lens of any one of embodiments 1 to 13, wherein the insert has a circular shape and comprises one sole peripheral edge.
17. The bi-layer contact lens of any one of Embodiments 1 to 16, wherein the improved lens performance provided relates to at least one of resisting lens deformation, resisting delamination of the insert from the bulk hydrogel material, controlling optical distortion, and/or improving wearer comfort.
18. The bi-layer contact lens of any one of Embodiments 1 to 17, wherein the insert has an outer diameter of between 7 mm to 13 mm.
19. The bi-layer contact lens of any one of Embodiments 1 to 18, wherein the crosslinked polymeric material of the insert has a first refractive index of at least 1.47, an oxygen permeability of at least 40 barrers.
20. The bi-layer contact lens of Embodiment 19, wherein the hydrogel bulk material has a second refractive index, wherein a differential between the first refractive index and the second refractive index is at least about 0.05.
21. The bi-layer contact lens of any one of Embodiments 1 to 20, wherein the insert comprises a diffractive lens element.
22. A method of optimizing performance of a bi-layer contact lens including an anterior surface, an opposite posterior surface, a bulk hydrogel material, an insert embedded in the bulk hydrogel material, an insert portion, and a carrier portion, wherein the insert is made of a crosslinked polymeric material different from the bulk hydrogel material and has a convex surface, an opposite concave surface, and at least one peripheral edge, wherein the insert portion is surrounded immediately by a carrier portion made of the bulk hydrogel material, wherein the insert portion comprises the insert and a layer of the bulk hydrogel material in direct contact with the insert via one of the convex and concave surfaces, the method comprising selective application of at least one design parameter selected from width, angle, shape configuration, and combinations thereof the peripheral edge of the insert.
23. The method of Embodiment 22, wherein the insert-carrier interface shape configuration of said at least one peripheral edge of the insert is selected from a straight angled shape configuration or a rounded shape configuration.
24. The method of Embodiment 22 or 23, wherein the layer of the bulk hydrogel material in the insert portion is directly in contact with the convex surface of the insert.
25. The method of any one of Embodiments 22 to 24, wherein the layer of the bulk hydrogel material in the insert portion is directly in contact with the concave surface of the insert.
26. The method of any one of Embodiments 22 to 25, wherein the insert has an annular ring shape and comprises an inner peripheral edge and outer peripheral edge.
27. The method of any one of Embodiments 22 to 26, wherein the optimized lens performance provided relates to at least one of resisting lens deformation, resisting delamination of the insert portion from the bulk hydrogel material, controlling optical distortion, and/or improving wearer comfort.

While the invention has been described with reference to example embodiments, it will be understood by those skilled in the art that a variety of modifications, additions and deletions are within the scope of the invention, as defined by the following claims.

What is claimed is:

1. A bi-layer contact lens comprising an anterior surface, an opposite posterior surface, a bulk hydrogel material, an insert embedded in the bulk hydrogel material, an insert portion, and a carrier portion, wherein the insert is made of a crosslinked polymeric material different from the bulk hydrogel material and has a convex surface, an opposite concave surface, and at least one peripheral edge, wherein the insert portion is surrounded immediately by the carrier portion made of the bulk hydrogel material, wherein the insert portion comprises the insert and a layer of the bulk hydrogel material in direct contact with the insert via one of the convex and concave surfaces, and wherein said at least one peripheral edge of the insert is configured to provide improved lens performance, wherein the bi-layer contact lens has a diameter of about 12.5 mm to about 15.5 mm, wherein said at least one peripheral edge of the insert is configured to provide improved lens performance by selective application of at least one design parameter selected from width, angle, shape configuration, and combinations thereof the peripheral edge of the insert.

2. The bi-layer contact lens of claim 1, wherein the shape configuration of said at least one peripheral edge of the insert is selected from a straight angled shape configuration or a rounded shape configuration.

3. The bi-layer contact lens of claim 2, wherein said at least one peripheral edge of the insert comprises a segmented edge geometry which comprises a tapered inner first segment an outer second segment, wherein the tapered inner first segment is flat or linear in cross-sectional profile (i.e., frustoconical in three-dimensional configuration) whereas the tapered outer second segment is arcute or curved in in cross-sectional profile, wherein the tapered inner first segment spans a radial distance of between about 0.1 to about 100 μm, wherein the tapered outer second segment spans a radial distance of between about 25 to about 500 μm.

4. The bi-layer contact lens of claim 3, wherein the tapered inner first segment extends at an angle of between about 90° to about 170° with respect to a cylindrical axis parallel to the lens central axis of the bi-layer contact lens, and/or wherein the tapered outer second segment is arcute and has a radius of curvature of from about 25 to about 500 μm.

5. The bi-layer contact lens of claim 3, wherein said at least one peripheral edge of the insert spans a radial distance of between about 0.25 mm to about 0.5 mm, measured in a transverse direction normal or perpendicular to the central axis of the bi-layer contact lens.

6. The bi-layer contact lens of claim 2, wherein said at least one peripheral edge is an angled, chamfered or beveled edge that defines a straight or linear frustoconical peripheral side surface, wherein the straight or linear frustoconical peripheral side surface is oriented or tapered at an oblique (arcute or obtuse) angle relative to a cylindrical axis parallel to and concentric with the central axial axis of the bi-layer contact lens, spaces a radial distance therefrom, and tapers outwardly wider towards the base curve of the bi-layer contact lens.

7. The bi-layer contact lens of claim 6, wherein the angled, chamfered or beveled edge spans a radial distance of between about 25 μm to about 500 μm, measured in a transverse direction normal or perpendicular to the central axis of the bi-layer contact lens.

8. The bi-layer contact lens of claim 2, wherein said at least one peripheral edge is a rounded, radiused or smoothly tapered edge that spans a radial distance of between about 0.25 mm to about 0.50 mm, measured in a transverse direction normal or perpendicular to the central axis of the bi-layer contact lens.

9. The bi-layer contact lens of claim 4, wherein the insert has an annular ring shape and said at least one peripheral edge comprises an inner peripheral edge and an outer peripheral edge, wherein the insert portion surrounds immediately a circular central lens portion.

10. The bi-layer contact lens of claim 9, wherein the outer peripheral edge of the insert has a diameter of from about 7 mm to about 13 mm and the inner peripheral edge of the insert has a diameter of from about 2 mm to about 5 mm.

11. The bi-layer contact lens of claim 4, wherein the insert has a circular shape and comprises one sole peripheral edge.

12. The bi-layer contact lens of claim 4, wherein the improved lens performance provided relates to at least one of resisting lens deformation, resisting delamination of the insert from the bulk hydrogel material, controlling optical distortion, and/or improving wearer comfort.

13. The bi-layer contact lens of claim 4, wherein the insert has an outer diameter of between 7 mm to 13 mm and comprises a diffractive lens element, wherein the crosslinked polymeric material of the insert has a first refractive index of at least 1.47, an oxygen permeability of at least 40 barrers, wherein the bulk hydrogel material has a second refractive index, wherein a differential between the first refractive index and the second refractive index is at least about 0.05.

14. The bi-layer contact lens of claim 7, wherein the insert has a circular shape and comprises one sole peripheral edge.

15. The bi-layer contact lens of claim 7, wherein the improved lens performance provided relates to at least one of resisting lens deformation, resisting delamination of the insert from the bulk hydrogel material, controlling optical distortion, and/or improving wearer comfort.

16. The bi-layer contact lens of claim 7, wherein the insert has an outer diameter of between 7 mm to 13 mm and comprises a diffractive lens element, wherein the crosslinked polymeric material of the insert has a first refractive index of at least 1.47, an oxygen permeability of at least 40 barrers, wherein the bulk hydrogel material has a second refractive index, wherein a differential between the first refractive index and the second refractive index is at least about 0.05.

17. The bi-layer contact lens of claim 8, wherein the insert has an outer diameter of between 7 mm to 13 mm and comprises a diffractive lens element, wherein the crosslinked polymeric material of the insert has a first refractive index of at least 1.47, an oxygen permeability of at least 40 barrers, wherein the bulk hydrogel material has a second refractive index, wherein a differential between the first refractive index and the second refractive index is at least about 0.05.

18. A method of optimizing performance of a bi-layer contact lens including an anterior surface, an opposite posterior surface, a bulk hydrogel material, an insert embedded in the bulk hydrogel material, an insert portion, and a carrier portion, wherein the insert is made of a crosslinked polymeric material different from the bulk hydrogel material and has a convex surface, an opposite concave surface, and at least one peripheral edge, wherein the insert portion is surrounded immediately by a carrier portion made of the bulk hydrogel material, wherein the insert portion comprises the insert and a layer of the bulk hydrogel material in direct contact with the insert via one of the convex and concave surfaces, the method comprising selective application of at least one design parameter selected from width, angle, shape configuration, and combinations thereof the peripheral edge of the insert.

19. The method of claim 18, wherein the insert-carrier interface shape configuration of said at least one peripheral edge of the insert is selected from a straight angled shape configuration or a rounded shape configuration.

20. The method of claim 19, wherein the insert has an annular ring shape and comprises an inner peripheral edge and outer peripheral edge, and/or wherein the optimized lens performance provided relates to at least one of resisting lens deformation, resisting delamination of the insert portion from the bulk hydrogel material, controlling optical distortion, and/or improving wearer comfort.
